(19) United States
(12) Patent Application Publication
(10) Pub. No.: US 2024/0125268 A1
(43) Pub. Date: Apr. 18, 2024

(54) V7 ENGINE

(71) Applicant: Lynn E. Peterson, Ludington, MI (US)

(72) Inventor: Lynn E. Peterson, Ludington, MI (US)

(21) Appl. No.: 17/968,288

(22) Filed: Oct. 18, 2022

(51) Int. Cl. F02B 75/18; F02B 75/22; F16F 15/24

(52) U.S. Cl. CPC F02B 75/18; F02B 75/22; F16F 15/24; F02B 2075/1828

(57) ABSTRACT

A system and method for a combustion engine having an engine block with a V-shape, where eight cylinder passages form two banks of four passages. Each cylinder passage receives a piston from a set of pistons coupled to a crankshaft. Seven ignition devices couple to seven of the eight cylinder passages. Every 102.85 to 102.86 degrees of rotation of the crankshaft, one of the seven ignition devices trigger combustion.

### TECHNICAL FIELD

The disclosure generally relates to an internal combustion engine having seven combustion cylinders, and more specifically, to an internal combustion engine having seven combustion cylinders divided into two groups where the two groups are arranged at an angle.

### BACKGROUND

In an internal combustion engine, an air-fuel mixture is provided to a chamber, more commonly known as a combustion cylinder. A movable piston coupled to a crankshaft is fitted within the cylinder. The piston, driven by the crankshaft, compresses the air-fuel mixture in the cylinder. A spark is provided to the compressed air-fuel mixture to generate a controlled burn of the air-fuel mixture. The pressure resulting from the controlled burn or explosion drives the piston downward. The crankshaft transforms the linear motion of the piston into rotational motion that can be output to a drive system.

Traditionally, the cylinders of the internal combustion engine can be arranged in an in-line configuration (straight engine) or in a V configuration (V or Vee engine). In the V engine, the cylinders are split into two cylinder banks; each bank typically having the same number of cylinders. The cylinder banks are arranged at an angle to each other, so that the banks form a “V” shape when viewed from the front of the engine.

Horsepower (HP) is a common unit of measurement used to describe the power of an automobile engine. The higher the HP, the greater the power sent to the wheels which can result in a higher speed of the automobile. HP of the internal combustion engine can depend the engine's size, capacity, number of valves, design, and more.

### BRIEF DESCRIPTION OF THE DRAWINGS

FIG. 1 is a schematic perspective view of an engine block of an internal combustion engine.

FIG. 2 is a schematic perspective view of the combustion engine with the engine block of FIG. 1 having pistons, rods, shafts, and a coupling assembly.

FIG. 3 is a schematic perspective view of headers for the combustion engine of FIG. 2.

FIG. 4 is a schematic cross section of a portion of the combustion engine taken at the IV-IV line in FIG. 3.

FIG. 5 is a schematic top down view of the engine block and pistons of FIG. 2 including spark plugs.

FIG. 6 is a schematically illustrates a firing order and timing for the combustion engine of FIG. 2-5.

FIG. 7 is a variation of the firing order and timing of FIG. 6.

FIG. 8 is a variation of cylinder numbering and firing order of FIG. 5.

### DETAILED DESCRIPTION

Aspects of the disclosure described herein are directed to an internal combustion engine having seven combustion cylinders, and more specifically, to an internal combustion engine having seven combustion cylinders divided into two groups where the two groups are arranged at an angle.

As used herein, the term “sealed sliding fit” refers to clearance between two objects so that one object can move or slide relative to another while remaining airtight or fluid-impermeable. That is, the diameter of a first object is larger than the diameter of a second object, so that the first object can receive the second object and the second object can slide relative to the first (or vice versa). The first or second object can include one or more seals, such that, as the second object (for example) slides or moves relative to the first object, an airtight or fluid-impermeable seal between the first object and the second object is maintained.

As used here, the term “generally equal” refers to two numerical values in which the percent difference between the two values is 5 percent or less.

As used herein, the term “generally parallel” is intended to mean that a straight line would intercept two surfaces, lines, or rays such that the angles the straight line makes with the intercepted surfaces, lines or rays are within 10 degrees.

As used herein, the terms “radial” or “radially” refer to a direction away from a common center. For example, in the overall context of a combustion engine, radial refers to a direction along a ray extending away from a centerline of a crankshaft or camshaft, while axial refers to a direction or ray along or generally parallel to the centerline of a crankshaft or camshaft.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of aspects of the disclosure described herein. Connection references (e.g., attached, coupled, secured, fastened, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

As used herein, the terms “first”, “second”, and “third” can be used interchangeably to distinguish one component from another and are not intended to signify location or importance of the individual components. The term “set” or a “set” of elements can be any number of elements, including only one.

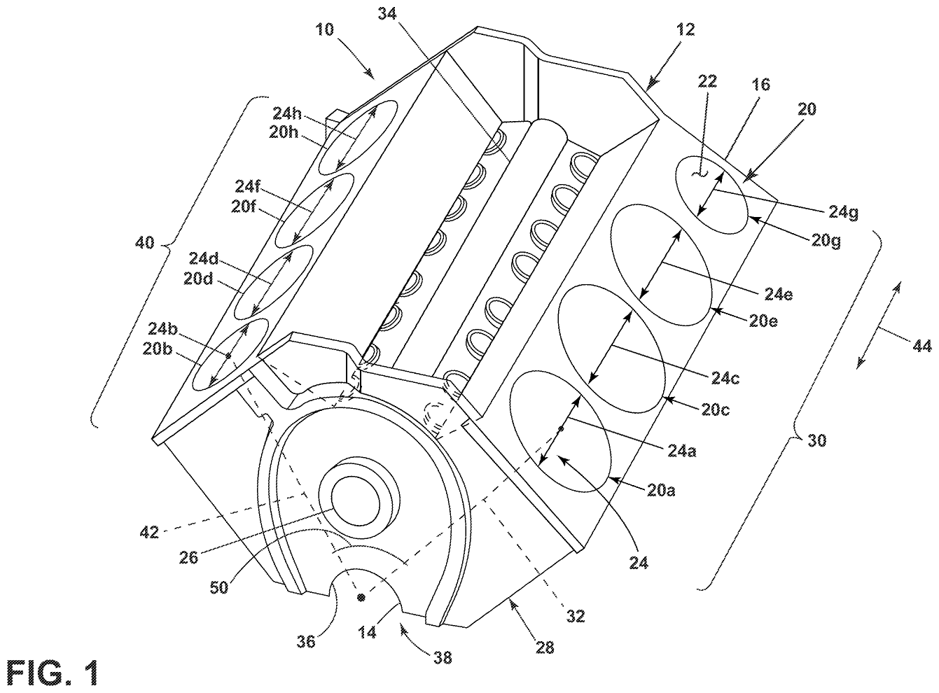

FIG. 1 illustrates an engine block 10 for an internal combustion engine. The engine block 10 includes a body 12 defining an inner engine surface 14 and an outer engine surface 16. The engine block 10, by way of example, can be for a 182.9 cubic inch or 3-liter internal combustion engine, while other suitable engine blocks are contemplated.

Eight bores or eight cylinder passages 20 extend from the outer engine surface 16 to the inner engine surface 14. That is, the eight cylinder passages 20 extending radially inward, where sidewalls 22 of the eight cylinder passages 20 couple the outer engine surface 16 and the inner engine surface 14 and define the eight cylinder passages 20 through the body 12.

By way of non-limiting example, the eight cylinder passages 20 are illustrated as a first cylinder passage 20a, a second cylinder passage 20b, a third cylinder passage 20c a fourth cylinder passage 20d, a fifth cylinder passage 20e, a sixth cylinder passage 20f, a seventh cylinder passage 20g, and an eighth cylinder passage 20h. The eight cylinder passages 20 are arranged as a first bank 30 and a second bank 40. By way of example, the first bank 30 can include the first cylinder passage 20a, the third cylinder passage 20c, the fifth cylinder passage 20e, and the seventh cylinder passage 20g. A first cylinder axis 32 can be defined by a longitudinal centerline extending through at least one of the cylinder passages 20a, 20c, 20e, 20g of the first bank 30. The second bank 40, by way of example, can include the second cylinder passage 20b, the fourth cylinder passage 20d, the sixth cylinder passage 20f, and the eighth cylinder passage 20h. A second cylinder axis 42 is defined by a longitudinal centerline extending through at least one cylinder passage 20b, 20d, 20f, 20h of the second bank 40.

The first bank 30 can be arranged at a v-angle relative to the second bank 40. That is, a v-angle or a bank angle 50 measured at the intersection of the first cylinder axis 32 and the second cylinder axis 42 (or crankshaft) is non-zero. The bank angle 50 can be greater than 50 degrees and less than 120 degrees. It is contemplated that the bank angle 50 is generally equal to 60 degrees or 90 degrees.

Each of the eight cylinder passages 20 includes bore diameters or a cylinder diameter 24. That is, a first diameter 24a is defined as the diameter of the first cylinder passage 20a. In one example, the first diameter 24a can be measured at the outer engine surface 16. Similarly, a second diameter 24b, a third diameter 24c, a fourth diameter 24d, a fifth diameter 24e, a sixth diameter 24f, a seventh diameter 24g, and an eight diameter 24h are defined, respectively, by the second cylinder passage 20b the third cylinder passage 20c, the fourth cylinder passage 20d, the fifth cylinder passage 20e, the sixth cylinder passage 20f, the seventh cylinder passage 20g, and the eighth cylinder passage 20h.

It is contemplated that at least two diameters of the eight cylinder diameters 24 are different. As illustrated, by way of example, the seventh diameter 24g is less than the fifth diameter 24e. It is contemplated that the first diameter 24a, third diameter 24c, and fifth diameter 24e from the first bank 30 are the same or generally equal in measurement. It is further contemplated that the second diameter 24b, fourth diameter 24d, sixth diameter 24f, and eighth diameter 24h from the second bank 40 can be equal. It is yet further contemplated that the second diameter 24b is the same of generally equal to the first diameter 24a. As illustrated, the first, second, third, fourth, fifth, sixth, and eighth diameters 24a, 24b, 24c, 24d, 24e, 24f, 24h are generally equal in measure, and can each be greater than the seventh diameter 24g. Since the seventh diameter 24g is smaller than the first, second, third, fourth, fifth, sixth, and eighth diameters 24a, 24b, 24c, 24d, 24e, 24f, 24h, the first, second, third, fourth, fifth, sixth, and eighth diameters 24a, 24b, 24c, 24d, 24e, 24f, 24h can be larger than traditionally used for same size block. Larger bore diameters can increase the intake flow and ultimately increase the horsepower of the combustion engine. Optionally, at least one diameter of the eight diameters 24 is greater than 3.72 inches. It is contemplated that a subset of the eight diameters 24, illustrated as the first, second, third, fourth, fifth, sixth, and eighth diameters 24a, 24b, 24c, 24d, 24e, 24f, 24h, can be generally equal to 3.98 inches.

An aperture 26 can pass through a side 28 of the body 12. A ridge or cam protrusion 34 can extend from a portion of the outer engine surface 16 of the body 12. A recess 36 can be formed at a lower portion 38 of the body 12.

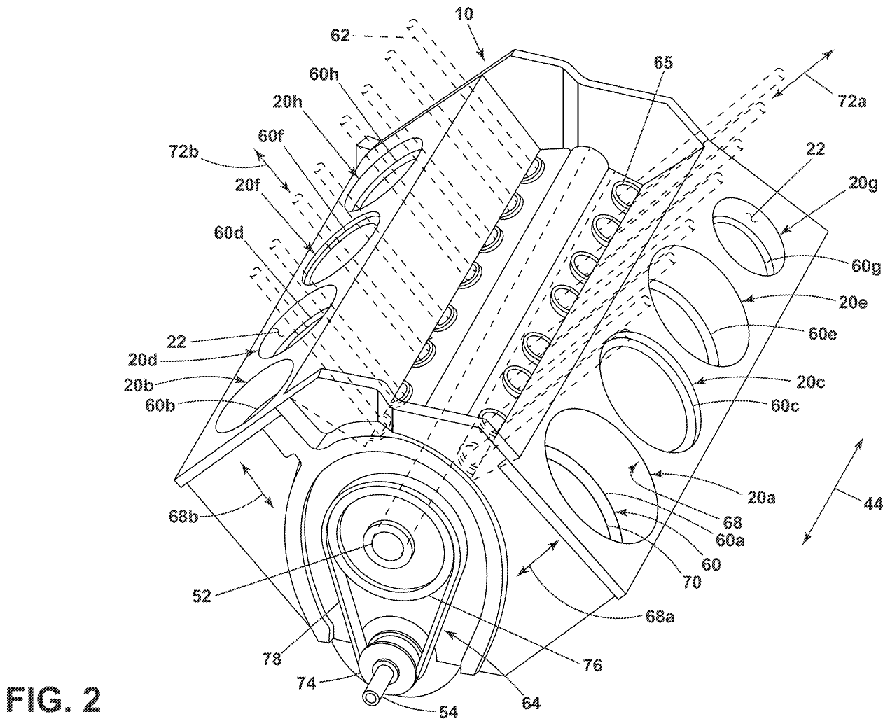

FIG. 2 further illustrates the engine block 10 where the engine block 10 includes a camshaft 52, a crankshaft 54, a set of pistons 60, a set of pushrods 62, and a coupling assembly 64. The aperture 26 can receive at least a portion of a camshaft 52. The cam protrusion 34 can define a chamber or region within the body 12 that receives or at least partially circumscribes a portion of the camshaft 52. The recess 36 in the body 12 can extend in an axial direction 44 beneath the body 12 or at the inner engine surface 14. The recess 36 can at least partially circumscribe the crankshaft 54, such that the crankshaft 54 is at least partially journaled by the engine block 10.

The set of pistons 60 are illustrated as eight pistons, where each of the eight pistons are positioned in a corresponding passage of the eight cylinder passages 20. A first piston 60a can be received by the first cylinder passage 20a. Similarly, a second piston 60b, a third piston 60c, a fourth piston 60d, a fifth piston 60e, a sixth piston 60f, a seventh piston 60g, and an eight piston 60h can be received, respectively, by the second cylinder passage 20b, the third cylinder passage 20c, the fourth cylinder passage 20d, the fifth cylinder passage 20e, the sixth cylinder passage 20f, the seventh cylinder passage 20g, and eighth cylinder passage 20h.

A sealed sliding fit exists between each piston of the set of pistons 60 and the sidewall 22 of each of the eight cylinder passages 20, permitting sliding movement of the pistons 60 relative to the cylinder passages 20, while maintaining a fluid seal. Additionally, the sealed sliding fit exists between the sidewalls 22 of the first, second, third, fourth, fifth, sixth, and eighth cylinder passages 20a, 20b, 20c, 20d, 20e, 20f, 20h and the first, second, third, fourth, fifth, sixth, and eighth pistons 60a, 60b, 60c, 60d, 60e, 60f, 60h. It is contemplated that the seventh cylinder passage 20g and the seventh piston 60g can have a slide fit between the sidewall 22 of the seventh cylinder passage 20g and the seventh piston 60g.

It should be appreciated that the height of each piston of the set of pistons 60 in FIG. 2 is schematic and for illustrative purposes only. The positioning of the set of pistons 60 within the eight cylinder passages 20 can vary during operation and is controlled by the crankshaft 54. That is, the set of pistons 60 are coupled to the common crankshaft 54. The crankshaft 54 extends in the axial direction 44 at least the length of the body 12. During rotation of the crankshaft 54, the set of pistons 60 linearly move in a radial direction illustrated by representative arrows 68a, 68b relative to the crankshaft 54. The radial direction can be defined relative to the longitudinal extent of the crankshaft 54. The crankshaft 54 can push or otherwise drive the set of pistons 60 (at different time intervals) towards or away from the outer engine surface 16 within the cylinder passages 20.

Each piston of the set of pistons 60 includes a crown 70. When a force is applied to the crown 70 of one or more pistons of the set of pistons 60, such as generated by combustion, the corresponding piston is linearly driven in the radial direction 68a, 68b towards the crankshaft 54, where the crankshaft 54 translates the force on the piston crown 70 from linear momentum to angular momentum. That is, the set of pistons 60 are continuously moving in and out along the radial direction 68a, 68b as the crankshaft 54 rotates. The crankshaft 54 both provides a force to each piston of the set of pistons 60 and at least a subset of the set of pistons 60, during a portion of the operation of the combustion engine, the crankshaft 54 receives a force (in the form of a torque) from at least a subset of the set of pistons 60.

The camshaft 52 can couple to or be located adjacent the set of pushrods 62. The set of pushrods 62 extend from the camshaft 52 through the body 12, where the set of pushrods 62 can extend past the outer engine surface 16 through pushrod apertures 65. As the camshaft 52 rotates, the set of pushrods 62 can move in a pushrod linear direction 72a, 72b which can be radially inward or outward defined relative to the camshaft 52. It is contemplated that each cylinder passage of the eight cylinder passages 20 has two corresponding pushrods from the set of pushrods 62.

The coupling assembly 64 can include a crankshaft pulley or crankshaft gear 74 coupled to the crankshaft 54, a camshaft pulley or camshaft gear 76 coupled to the camshaft 52, and a chain or belt 78. The belt 78 rotatably couples the camshaft gear 76 and crankshaft gear 74, so that the rotation of the crankshaft 54 drives rotation to the camshaft 52. The camshaft gear 76 and crankshaft gear 74 can be any number of pulleys or gears, or arranged at a particular gear ratio, to provide the correct rotational output to the camshaft 52 from the crankshaft 54. The belt 78, while illustrated as a single belt, can be any number of chains or belts.

It is further contemplated that the camshaft 52 can be an overhead camshaft located above the body 12. It is further contemplated that the camshaft 52 can be two overhead camshafts, where each camshaft is located above the first bank 30 and the second bank 40. Each of the two camshafts can control the relative pushrods of the corresponding bank above which the camshaft is located.

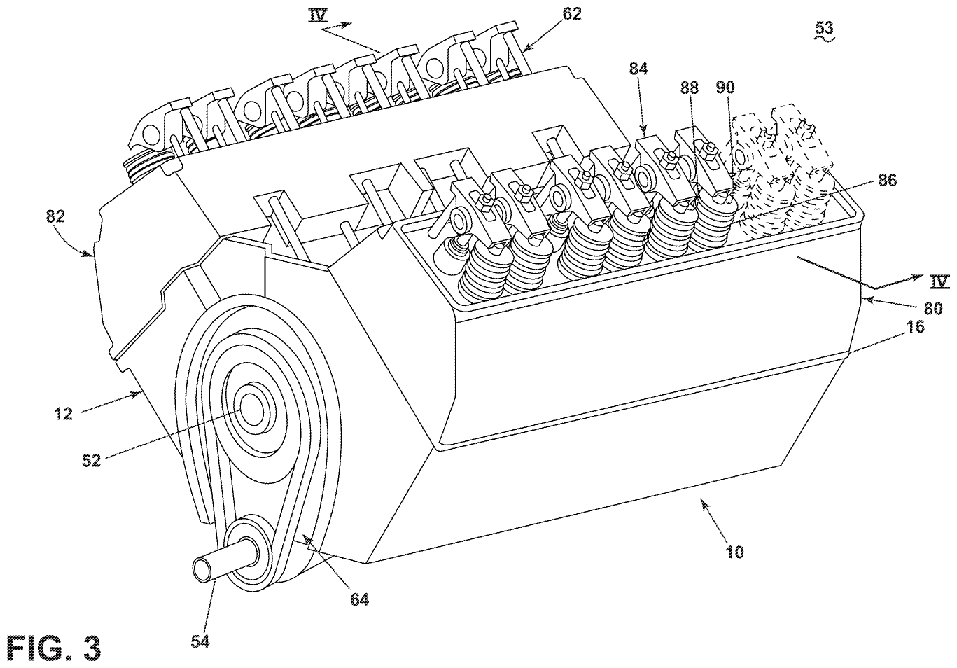

FIG. 3 further illustrates the engine block 10 of FIG. 2 as a combustion engine 53. A first cylinder head assembly 80 couples to the body 12 at the outer engine surface 16. The first cylinder head assembly 80 can cover the first bank 30. The first cylinder head assembly 80 can include four unitarily formed cylinder heads or roofs; each corresponding to the first, third, fifth, and seventh cylinder passage 20a, 20c, 20e, 20g. While the first cylinder head assembly 80 is illustrated as having a uniform exterior shape, it is contemplated that a portion of the first cylinder head assembly 80 or the cylinder head or roof corresponding to the seventh cylinder passage 20g can be smaller than the portions of the first cylinder head assembly 80 or the cylinder heads or roof portions of

A second cylinder head assembly 82 couples to the body 12 at the outer engine surface 16 and can cover the second bank 40. The second cylinder head assembly 82 can include four unitarily formed cylinder heads or roofs; each corresponding to the second, fourth, sixth, and eighth cylinder passage 20b, 20d, 20f, 20h.

The set of pushrods 62 can couple to rocker arms or rocker heads 84. Each of the rocker heads 84 includes valve springs 86. The rocker heads 84 can couple to inlet valves 88 and outlet valves 90 located at least at the first, second, third, fourth, fifth, sixth, and eighth cylinder passages 20a, 20b, 20c, 20d, 20e, 20f, 20h. Optionally, the seventh cylinder passage 20g can include rocker heads 84, valve springs 86, inlet valve 88, or outlet valve 90.

As the crankshaft 54 rotates the camshaft 52 via the coupling assembly 64, the set of pushrods 62 are moved in the pushrod linear direction 72a, 72b. When moved axially outward, the set of pushrods 62 can open the inlet valves 88 or the outlet valves 90 via the rocker head 84. The valve springs 86 ensures the inlet valves 88 or the outlet valves 90 are closed when the corresponding push of the set of pushrod 62 no longer presses against the rocker head 84.

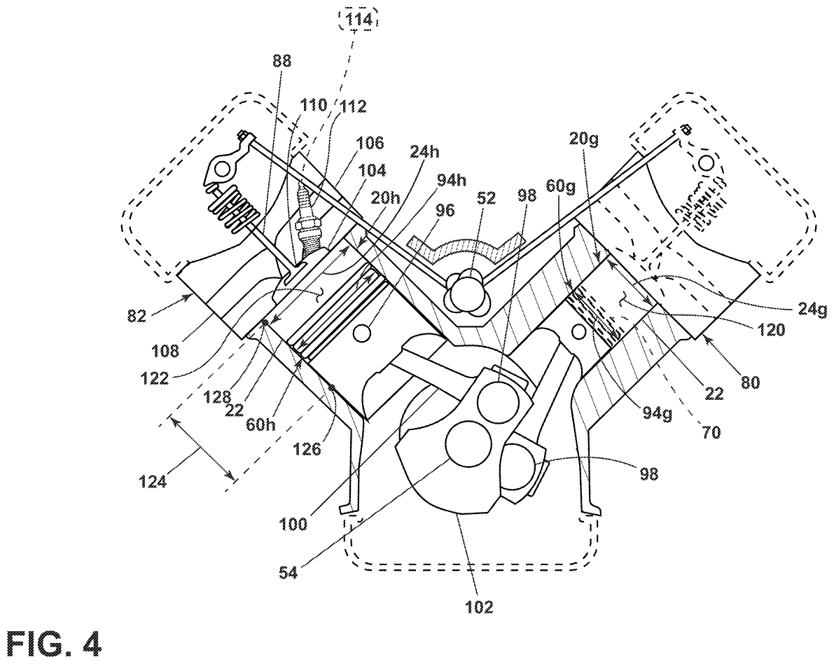

FIG. 4 is an exemplary cross section taken across the body 12 at the inlet valves 88 of the eighth cylinder passage 20h and the seventh cylinder passage 20g. As illustrated, the seventh cylinder passage 20g has the seventh diameter 24 and the eighth cylinder passage 20h has the eighth diameter 24h. The diameter of each piston of the set of pistons 60 is determined by or is complimentary to the sidewalls 22 defining the diameter 24 of the corresponding cylinder passage of the eight cylinder passages 20. For example, the seventh piston 60g can have a diameter 94g that is configured to provide a sliding fit between the seventh piston 60g and the seventh cylinder passage 20g. That is, the diameter 94g of the seventh piston 60g is less (approximately 5% difference or less) than the diameter 24g of the seventh cylinder passage 20g. The eighth piston 60h can have a diameter 94h that is slightly less (approximately 2% difference or less) than the eighth diameter 24h to provide a sealed sliding fit between the eighth piston 60h and the eighth cylinder passage 20h. It is contemplated that the eighth piston diameter 94h is greater than the seventh piston diameter 94g.

The seventh piston 60g and the eighth piston 60h couple to the crankshaft 54 via a first connecting pin 96 and a second connecting pin 98, as well as a bar or beam 100. Crank webs or counterweights 102 can be used to balance the crankshaft 54. While illustrated as having a common journal, a split journal crankshaft is also contemplated.

The second cylinder head assembly 82 can include a roof or cylinder head 104, an inlet passage 106, and an outlet passage 108. The inlet passage 106 can fluidly connect a fuel-air source (not shown) with an inlet 110 of the eighth cylinder passage 20h. The flow of the fuel-air mix from the fuel-air source into the eighth cylinder passage 20h at the inlet 110 can be controlled, in part, by the opening and closing of the inlet valve 88. In one non-limiting example, it is contemplated that at least one of the inlets 110 or the inlet valves 88 can have a diameter between 2.150-2.190 inches. The outlet passage 108 can fluidly connect the eighth cylinder passage 20h to an exhaust system (not shown). The flow of combusted gasses from the eighth cylinder passage 20h can at least be partially controlled by the outlet valve 90 (FIG. 3).

An ignition device, illustrated as a spark plug 112, can be in communication with the eighth cylinder passage 20h. While illustrated as coupled to the cylinder head 104, other locations for the spark plug 112 are contemplated, such that a spark is able to be provided to the eighth cylinder passage 20h. The spark plug 112 can receive an electrical signal from one or more timing mechanisms or devices 114, such as, but not limited to, a distributor or internal computer.

A combustion chamber 122 can be defined the sidewalls 22, the piston crown 70, and the cylinder head 104. An ignition device such as, for example, the spark plug 112 is in communication with the combustion chamber 122 to provide ignition or spark for combustion.

A dead cylinder or a passive chamber 120 can be defined by the seventh cylinder passage 20g, the piston crown 70, and a portion of the first cylinder head assembly 80. The passive chamber 120 is used to accommodate assemblies that balance the crankshaft 54 or camshaft 52. Since no combustion takes place in the passive chamber 120, the seventh piston 60g is a balancing structure and does not provide a driving force to the crankshaft 54.

While illustrated as the seventh piston 60g, it is contemplated that other structures can be used in place or in addition to the seventh piston 60g to balance the crankshaft 54 during operation of the combustion engine 53. By way of non-limiting example, a bob weight or additional springs can be coupled to or replace the piston head 60g. The passive chamber 120 defined in part by the seventh cylinder passage 20h provides the benefit of balancing the force provided by combustion in the seven combustion chambers 122 defined, in part, by the first, second, third, fourth, fifth, sixth, and eighth cylinder passages 20a, 20b, 20c, 20d, 20e, 20f, 20h.

A stroke length 124 can be measured from a near point 126 to a far point 128. The near point 126 is defined by the piston crown 70 when the piston crown 70 is radially closest to the crankshaft 54 during operation. The far point 128 is defined by the piston crown 70 when the piston crown 70 is radially farthest from the crankshaft 54.

In one example, the combustion engine 53 can be a short-stroke combustion engine. That is, the stroke length 124 of the majority of the set of pistons 60 is less than a diameter of the associated cylinder passage. More specifically, the first, second, third, fourth, fifth, sixth, and eighth diameters 24a, 24b, 24c, 24d, 24e, 24f, 24h can be greater than the corresponding stroke lengths 124. That is, the ratio of the stroke length 124 to each of the first, second, third, fourth, fifth, sixth, and eighth diameters 24a, 24b, 24c, 24d, 24e, 24f, 24h is less than 1:1. However, it is contemplated that the ratio of the stroke length 124 to the first, second, third, fourth, fifth, sixth, and eighth diameters 24a, 24b, 24c, 24d, 24e, 24f, 24h is less than 1:1.25. The diameter 24g of the seventh cylinder passage 20g can be less than the first, second, third, fourth, fifth, sixth, and eighth diameters 24a, 24b, 24c, 24d, 24e, 24f, 24h. Optionally, the ratio of the stroke length 124 to the seventh diameter 24g can be 1:1 or less. Since only the stroke length 124 of the seventh piston 60g in the seventh cylinder passage 20g forms a square or long-stroke ratio, the combustion engine 53 can still be considered a short-stroke combustion engine.

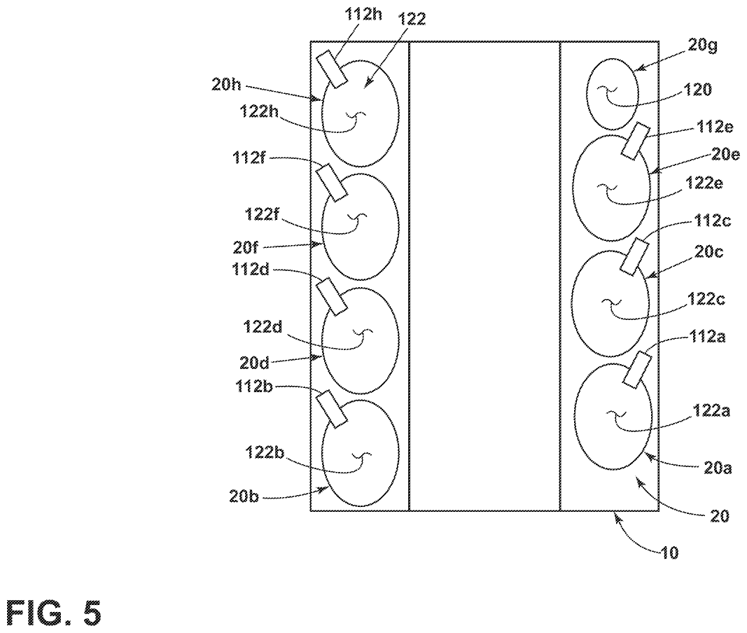

FIG. 5 is a top-down schematic view of the engine block 10 illustrating the combustion chambers 122 and the passive chamber 120 at least partially defined by the eight cylinder passages 20. The first, second, third, fourth, fifth, and sixth cylinder passages 20a, 20b, 20c, 20d, 20e, 20f include similar structure to the eighth cylinder passage 20h (FIG. 4), wherein the first, second, third, fourth, fifth, sixth, and eighth cylinder passages 20a, 20b, 20c, 20d, 20e, 20f, 20h partially define seven combustion chambers.

That is, the first cylinder passage 20a defines, at least in part, a first combustion chamber 122a in communication with a first spark plug 112a. The second cylinder passage 20b defines, at least in part, a second combustion chamber 122b in communication with a second spark plug 112b. The third cylinder passage 20c defines, at least in part, a third combustion chamber 122c in communication with a third spark plug 112c. The fourth cylinder passage 20d defines, at least in part, a fourth combustion chamber 122d in communication with a fourth spark plug 112d. The fifth cylinder passage 20e defines, at least in part, a fifth combustion chamber 122e in communication with a fifth spark plug 112e. The sixth cylinder passage 20f defines, at least in part, a sixth combustion chamber 122f in communication with a sixth spark plug 112f. The seventh cylinder passage 20g defines, at least in part, the passive chamber 120. The eighth cylinder passage 20h defines, at least in part, a seventh combustion chamber 122h in communication with a seventh spark plug 112h.

The order in which the combustion chambers fire can be the first combustion chamber 122a at the first cylinder passage 20a, the seventh combustion chamber 122h at the eighth cylinder passage 20h, the fourth combustion chamber 122d at the fourth cylinder passage 20d, the third combustion chamber 122c at the third cylinder passage 20c, the sixth combustion chamber 122f at the sixth cylinder passage 20f, the fifth combustion chamber 122e at the fifth cylinder passage 20e, and the second combustion chamber 122b at the second cylinder passage 20b.

Alternatively, by way of non-limiting example, the seventh cylinder passage 20g can at least partially define a combustion chamber, while the first cylinder passage 20a can define a passive chamber. In this example, the order in which the combustion chambers fire can be the first combustion chamber at the second cylinder passage 20b, the sixth combustion chamber at the seventh cylinder passage 20g, the seventh combustion chamber (not shown) at the eighth cylinder passage 20h, the third combustion chamber at the fourth cylinder passage 20d, the fourth combustion chamber at the fifth cylinder passage 20e, the fifth combustion chamber at the sixth cylinder passage 20f, and the second combustion chamber at the third cylinder passage 20c,

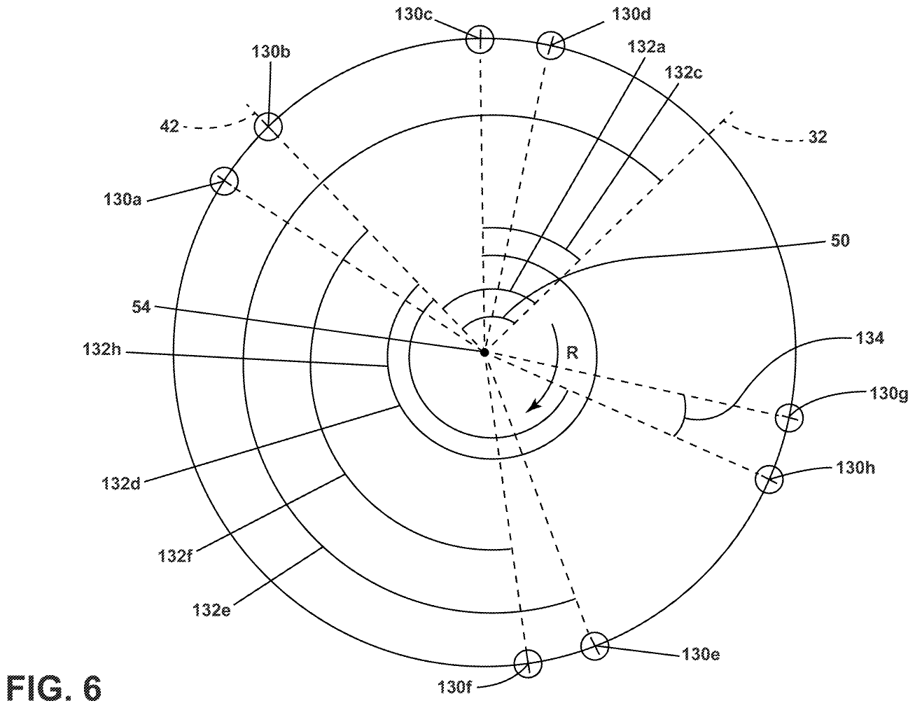

FIG. 6 is a schematic illustration of the crankshaft 54 and the relative position of the set of pistons 60 for a combustion engine with the bank angle 50 equal to 90 degrees. That is, the angle between the first cylinder axis 32 representing the first bank 30 (see FIG. 1) and the second cylinder axis 42 representing the second bank 40 (see FIG. 1) taken at the crankshaft 54 is 90-degrees, while it is contemplated that the angle can be between 89 and 91 degrees.

A first point 130a corresponds to the first piston 60a received by the first cylinder passage 20a. Similarly, a second point 130b, a third point 130c, a fourth point 130d, a fifth point 130e, a sixth point 130f, a seventh point 130g, and an eighth point 130h correspond to the second piston 60b, the third piston 60c, the fourth piston 60d, the fifth piston 60e, the sixth piston 60f, the seventh piston 60g, and the eight piston 60h, respectively.

As illustrated, the second point 130b is aligned with the second cylinder axis 42 which can indicate that the second piston 60b is applying or is about to apply a force to the crankshaft 54 due to combustion. When the second point 130b aligns with the second cylinder axis 42 (indicative of the second bank 40), the second piston 60g begins to apply a driving force to the crankshaft 54.

Point angles can be measured counterclockwise from the first cylinder axis 32 or the second cylinder axis 42 relative to the radius of the crankshaft 54. As illustrated, the first point 130a has a first point angle 132a measuring between 102.85 and 102.86 degrees from the first cylinder axis 32. Therefore, as the crankshaft 54 (schematically illustrated) rotates between 102.85 and 102.86 degrees in a direction R, the first point 130a aligns with the first cylinder axis 32 and the first piston 60a in the first cylinder passage 20a would apply a force or begin to apply a force to the crankshaft 54.

The eighth point 130h has a point angle 132h of 205.70-205.72 degrees from the second cylinder axis 42. Therefore, as the crankshaft 54 rotates approximately 205.71 degrees (approximately 102.85-102.86 degrees twice), the eighth point 130h will align with the second cylinder axis 42 and the eighth piston 60h would apply a force or begin to apply a force to the crankshaft 54. As used herein, the term “approximately” means within 0.1 degrees or less of the angle indicated.

The fourth point 130d has a fourth point angle 132d of approximately 308.55-308.58 degrees from the second cylinder axis 42. Therefore, as the crankshaft 54 rotates approximately 308.57 degrees (or the crankshaft 54 rotates in direction R approximately 102.85-102.86 degrees three times), the fourth point 130d will align with the second cylinder axis 42 and the fourth piston 60d in the fourth cylinder passage 20d would apply a force or begin to apply a force to the crankshaft 54.

The third point 130c has a third point angle 132c of approximately 51.40-51.44 degrees or 411.40-411.44 degrees from the first cylinder axis 32. Therefore, as the crankshaft 54 rotates approximately 411.42 degrees in direction R (approximately 102.85-102.86 degrees four times), the third point 130c aligns with the first cylinder axis 32 and the third piston 60c would apply a force or begin to apply a force to the crankshaft 54.

The sixth point 130f has a sixth point angle 132f of approximately 154.25-154.30 degrees or 514.25-154.30 degrees from the second cylinder axis 42. Therefore, as the crankshaft 54 rotates approximately 514.29 degrees in direction R (approximately 102.86-102.86 degrees five times), the third point 130f aligns with the second cylinder axis 42 and the sixth piston 60f would apply a force or begin to apply a force to the crankshaft 54.

The fifth point 130e has a fifth point angle 132e of approximately 257.10-257.16 degrees or 617.10-617.16 degrees from the first cylinder axis 32. Therefore, as the crankshaft 54 rotates approximately 617.14 degrees in the direction R (approximately 102.85-102.86 degrees six times), the fifth point 130e aligns with the first cylinder axis 32 and the fifth piston 60e in the would apply a force or begin to apply a force to the crankshaft 54 due to combustion provided by a fifth ignition device or a fifth spark plug 112e.

When the crankshaft 54 rotates approximately 102.85-102.86 degrees seven times, the crankshaft 54 rotates a total of 720.00 degrees or 360.00 degrees twice, such that the second point 130b will again align with the second cylinder axis 42, returning to its initial position. This establishes an even firing interval of 102.85-102.86, or more specifically, 102.8571. That is, every 102.8571 degrees of rotation of the crankshaft 54, firing or combustion in the seven combustion chambers 122 provides energy to the crankshaft 54.

The seventh point 130g corresponds to the seventh piston 60g or counterweight in the seventh cylinder passage 20g. The positioning of 130g is important to maintaining the balance of the crankshaft 54. The seventh point 130g has a location angle 134 measured counterclockwise from the eighth point 130h of approximately 12.84 degrees. Recall that the seventh cylinder passage 20g defines the passive chamber 120, therefore no driving force is applied when the seventh point 130g aligns with the first cylinder axis 32.

It is contemplated that the spark provided to the combustion chamber can occur every 102.8571 degrees. The spark provided corresponds to a piston position such that the energy provided to the piston is complementary with the rotational position of the crankshaft 54. The spark from the spark plug 112 can be provided to the respective combustion chamber 122 prior to or when the points 130a, 130b, 130c, 130d, 130e, 130f, 130h align with the first cylinder axis 32 or the second cylinder axis 42. When providing the spark prior to alignment, it is contemplated that the combustion resultant of such a spark is timed to correspond to alignment of the points 130a, 130b, 130c, 130d, 130e, 130f, 130h with the related rotational position of the crankshaft 54.

In operation, the fuel-air mixture is provided in a predetermined order to, for example, the seven combustion chambers 122 defined in part by the first, eighth, fourth, third, sixth, fifth, and second cylinder passages 20a, 20h, 20d, 20c, 20f, 20e, 20b (FIG. 5). As there are only the seven combustion chambers 122, only seven ignition devices or spark plugs 112 are required for operation.

The inlet valve 88 opens via one of the pushrods from the set of pushrods 62 to allow the fuel-air mixture into the combustion chamber 122 through the inlet 110. The inlet 110 is then sealed by the inlet valve 88 via the motion of the camshaft 52 and positioning of the corresponding pushrod 62. The fuel-air mixture in the combustion chamber 122 is compressed by one of the pistons from the set of pistons 60, and the piston crown 70 is moved towards the cylinder head 104. During compression, the spark plug 112 can ignite the fuel air mixture in the combustion chamber 122, applying a driving force to the piston crown 70 which pushes the piston away from the cylinder head 104. The piston 60 drives the crankshaft 54, which receives the linear energy from the piston and transforms it to rotational energy. The outlet valve 90 can be opened so that when the piston 60 is lifted towards the cylinder head 104 by the crankshaft 54 (in an exhaust stroke), the combusted gasses are exhausted through the outlet passage 108. In this respect, the at certain cycles of the operation the crankshaft 54 provides a force to the set of pistons 60, whereas during combustion, the pistons in communication with combustion chambers 122 can provide force to the crankshaft 54.

The crankshaft 54 rotatably drives the camshaft 52 via the coupling assembly 64. The camshaft 52 provides a linear force to the set of pushrods 62 that can be coupled to the rocker heads 84. The rocker heads 84 and the valve springs 86 open and close the inlet valve 88, to allow the fuel-air mixture to enter the combustion chambers 122. After combustion, the outlet valve 90 works with the piston 60 to exhaust the combusted gasses.

The crankshaft 54 is driven by the seven of the eight pistons 60. More specifically, the crankshaft 54 is driven by the first, second, third, fourth, fifth, sixth, and eighth pistons 60a, 60b, 60c, 60d, 60e, 60f, 60h. The seven pistons 60a, 60b, 60c, 60d, 60e, 60f, 60h partially define seven combustion chambers 122, including the first, second, third, fourth, fifth, sixth, and eight combustion chambers 122a, 122b, 122c, 122d, 122e, 122f, 122h in communication with the seven ignition devices 112 including the first, second, third, fourth, fifth, sixth, and seventh spark plugs 112a, 112b, 112c, 112d, 112e, 112f, 112h.

The driving of the crankshaft 54 by the seven pistons (the first, second, third, fourth, fifth, sixth, and eighth pistons 60a, 60b, 60c, 60d, 60e, 60f, 60h) is timed such that one of the seven ignition devices (the first, second, third, fourth, fifth, sixth, and seventh spark plugs 112a, 112b, 112c, 112d, 112e, 112f, 112h) initiates combustion every 102.85 to 102.86 degrees of rotation of the crankshaft 54. The firing order of the seven ignition devices or the seven spark plugs 112 can be the first spark plug 112a in communication with the first combustion chamber 122a. Next, the seventh spark plug 112h in communication with the seventh combustion chamber 122h partially defined by the eighth cylinder passage 20h sparks, followed by the fourth spark plug 112d in communication with the fourth combustion chamber 122d. After the fourth spark plug 112d initiates combustion, the third spark plug 112c in communication with the third combustion chamber 122c sparks. Then the sixth spark plug 112f in communication with the sixth combustion chamber sparks, followed by the fifth spark plug 112e in communication with the fifth combustion chamber 122e. The second spark plug 112b in communication with the second combustion chamber 122b sparks. The process repeats with the sparking of the first spark plug 112a again after the second spark plug 112b initiates combustion. The combustion firing order ensures that two adjacent cylinders in the same bank do no sequentially fire.

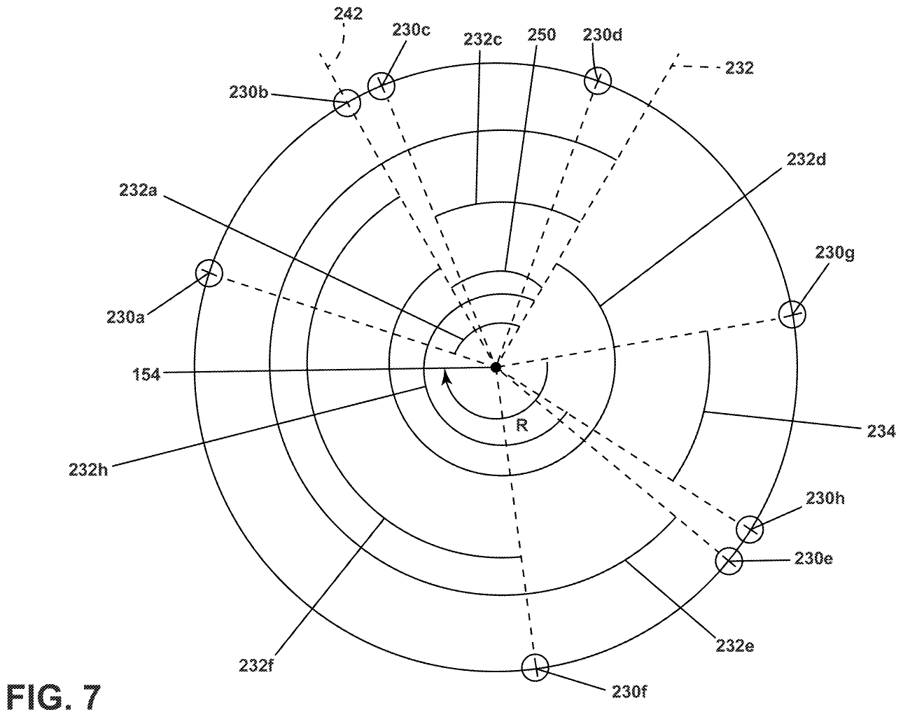

FIG. 7 is a schematic illustration of a crankshaft 154 and the relative position of the set of pistons 60 illustrated as corresponding to eight points 230a, 230b 230c, 230d, 230e, 230f, 230g, 230h. A bank angle 250 equal to 60 degrees can be defined as the angle between a first cylinder axis 232 representing a first bank such as the first bank 30 (see FIG. 1), and a second cylinder axis 242 representing a second bank such as the second bank 40 (see FIG. 1). However, it is contemplated that the bank angle 250 can be between 58 degrees and 62 degrees.

The crankshaft 154, the eight points eight points 230a, 230b 230c, 230d, 230e, 230f, 230g, 230h, and the bank angle 250 defined by the first cylinder axis 232 and the second cylinder axis 242 can be similar to the crankshaft 54, the eight points 130, and the bank angle 50 defined by the first cylinder axis 32 and the second cylinder axis 42, and therefore, like parts will be identified with like numerals increased by 200, with it being understood that the description of the like parts of the crankshaft 54, the eight points 130, and the bank angle 50 defined by the first cylinder axis 32 and the second cylinder axis 42 applies to the crankshaft 154, the eight points eight points 230a, 230b 230c, 230d, 230e, 230f, 230g, 230h, and the bank angle 250 defined by the first cylinder axis 232 and the second cylinder axis 242 unless otherwise noted.

Each point of the eight points eight points 230a, 230b 230c, 230d, 230e, 230f, 230g, 230h corresponds to an ignition position or timing at which one of the seven spark plugs 112 ignites. Alternatively, the eight points eight points 230a, 230b 230c, 230d, 230e, 230f, 230g, 230h can correspond to a position in which one of seven pistons of the set of pistons 60 provides a driving force to the crankshaft 154.

As the crankshaft 154 rotates in a direction R, one of the eight points 230a, 230b 230c, 230d, 230e, 230f, 230g, 230h can align with the first cylinder axis 232 or the second cylinder axis 242. Alignment with the first cylinder axis 32 or the second cylinder axis 42, can indicate when combustion occurs or is occurring and the piston corresponding to the combustion applies a driving force to the crankshaft 154.

A first point 230a corresponds to the first piston 60a received by the first cylinder passage 20a. Similarly, a second point 230b, a third point 230c, a fourth point 230d, a fifth point 230e, a sixth point 230f, a seventh point 230g, and an eighth point 230h correspond to the second piston 60b, the third piston 60c, the fourth piston 60d, the fifth piston 60e, the sixth piston 60f, the seventh piston 60g, and the eight piston 60h, respectively.

As illustrated, the second point 230b is aligned with the second cylinder axis 242 which can indicate that the second piston 60b is applying or is about to apply a force to the crankshaft 154 due to combustion. When the second point 230b aligns with the second cylinder axis 242 (indicative of the second bank 40), the second piston 60g begins to apply a driving force to the crankshaft 154.

Point angles can be measured counterclockwise from the first cylinder axis 232 or the second cylinder axis 242 relative to the radius of the crankshaft 154. As illustrated, the first point 230a has a first point angle 232a measuring between 102.85 and 102.86 degrees from the first cylinder axis 232. Therefore, as the crankshaft 154 (schematically illustrated at the center of rotation) rotates between 102.85 and 102.86 degrees in a direction R, the first point 230a aligns with the first cylinder axis 232 and the first piston 60a in the first cylinder passage 20a would apply a force or begin to apply a force to the crankshaft 154.

The eighth point 230h has a point angle 232h of 205.70-205.72 degrees from the second cylinder axis 242. Therefore, as the crankshaft 154 rotates approximately 205.71 degrees (approximately 102.85-102.86 degrees twice), the eighth point 230h will align with the second cylinder axis 242 and the eighth piston 60h would apply a force or begin to apply a force to the crankshaft 154.

The fourth point 230d has a fourth point angle 232d of approximately 308.55-308.58 degrees from the second cylinder axis 242. Therefore, as the crankshaft 154 rotates approximately 308.57 degrees (or the crankshaft 154 rotates in direction R approximately 102.85-102.86 degrees three times), the fourth point 230d will align with the second cylinder axis 242 and the fourth piston 60d in the fourth cylinder passage 20d would apply a force or begin to apply a force to the crankshaft 154.

The third point 230c has a third point angle 232c of approximately 51.40-51.44 degrees or 411.40-411.44 degrees from the first cylinder axis 232. Therefore, as the crankshaft 154 rotates approximately 411.42 degrees in direction R (approximately 102.85-102.86 degrees four times), the third point 230c aligns with the first cylinder axis 232 and the third piston 60c would apply a force or begin to apply a force to the crankshaft 154.

The sixth point 230f has a sixth point angle 232f of approximately 154.25-154.30 degrees or 514.25-154.30 degrees from the second cylinder axis 242. Therefore, as the crankshaft 154 rotates approximately 514.29 degrees in direction R (approximately 102.86-102.86 degrees five times), the third point 230f aligns with the second cylinder axis 242 and the sixth piston 60f would apply a force or begin to apply a force to the crankshaft 154.

The fifth point 230e has a fifth point angle 232e of approximately 257.10-257.16 degrees or 617.10-617.16 degrees from the first cylinder axis 232. Therefore, as the crankshaft 154 rotates approximately 617.14 degrees in the direction R (approximately 102.85-102.86 degrees six times), the fifth point 130e aligns with the first cylinder axis 232 and the fifth piston 60e in the would apply a force or begin to apply a force to the crankshaft 154.

When the crankshaft 154 rotates approximately 102.85-102.86 degrees seven times, the crankshaft 154 rotates a total of 720.00 degrees or 360.00 degrees twice, such that the second point 230b will again align with the second cylinder axis 242, returning to its initial position. This establishes an even firing interval of 102.85-102.86, or more specifically, 102.8571. That is, every 102.8571 degrees of rotation of the crankshaft 154, firing or combustion in the seven combustion chambers 122 provides energy to the crankshaft 154.

The seventh point 230g corresponds to the seventh piston 60g or counterweight in the seventh cylinder passage 20g. The positioning of 230g is important to maintaining the balance of the crankshaft 154. The seventh point 230g is illustrate, by way of example, at a location angle 234 measured counterclockwise from the eighth point 230h of approximately 42.84 degrees. Recall that the seventh cylinder passage 20g defines the passive chamber 120, therefore no driving force is applied when the seventh point 230g aligns with the first cylinder axis 232.

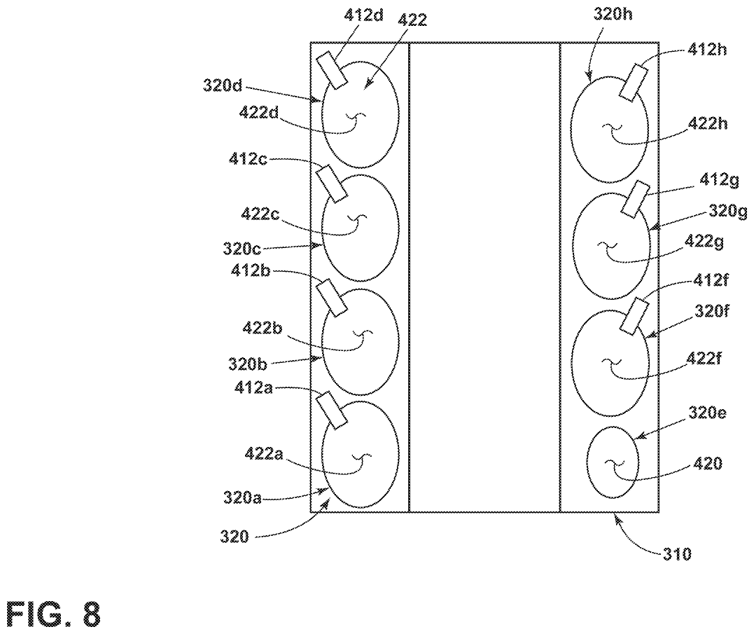

FIG. 8 is a top-down schematic view of the engine block 310 illustrating seven combustion chambers 422 at least partially defined by first, second, third, fourth, sixth, seventh, and eighth cylinder passages 320a, 320b, 320c, 320d, 320f, 320g, 320h and a passive chamber 420 defined by a fifth cylinder passage 320e.

The first, second, third, fourth, sixth, seventh, and eighth cylinder passages 320a, 320b, 320c, 320d, 320f, 320g, 320h include similar structure to the eighth cylinder passage 20h (FIG. 4), wherein the first, second, third, fourth, sixth, seventh, and eighth cylinder passages 320a, 320b, 320c, 320d, 320f, 320g, 320h at least partially define seven combustion chambers.

That is, the first cylinder passage 320a defines, at least in part, a first combustion chamber 422a in communication with a first spark plug 412a. The second cylinder passage 320b defines, at least in part, a second combustion chamber 422b in communication with a second spark plug 412b. The third cylinder passage 320c defines, at least in part, a third combustion chamber 422c in communication with a third spark plug 412c. The fourth cylinder passage 320d defines, at least in part, a fourth combustion chamber 422d in communication with a fourth spark plug 412d. The fifth cylinder passage 320e defines, at least in part, the passive chamber 320. The sixth cylinder passage 320f defines, at least in part, a fifth combustion chamber 422f in communication with a fifth spark plug 412f. The seventh cylinder passage 320g defines, at least in part, a sixth combustion chamber 422g in communication with a sixth spark plug 412g. The eighth cylinder passage 320h defines, at least in part, a seventh combustion chamber 422h in communication with a seventh spark plug 412h.

The firing order, for example, of the seven ignition devices can be, but is not limited to, the first ignition device 412a in communication with the first combustion chamber 422a partially defined by the first cylinder passage 320a; then the third ignition device 412c in communication with the third combustion chamber 422c partially defined by the third cylinder passage 320c; then the sixth ignition device 412g in communication with the sixth combustion chamber 422g partially defined by the seventh cylinder passage 320g; then the second ignition device 412b in communication with the second combustion chamber 422b partially defined by the second cylinder passage 320b; then the fifth ignition device 412f in communication with the fifth combustion chamber 422f partially defined by the sixth cylinder passage 320f; then the fourth ignition device 412d in communication with the fourth combustion chamber 422d partially defined by the fourth cylinder passage 320d; and then the seventh ignition device 412h in communication with a seventh combustion chamber 422h partially defined by the eighth cylinder passage 320h. Alternatively, the first, second, third, fourth, fifth, sixth, and seventh cylinder passages 320a, 320b, 320c, 320d, 320e, 320f, 320g can define, at least in part, respective first, second, third, fourth, fifth, sixth, and seventh combustion chambers (not shown) in communication with the first, second, third, fourth, fifth, sixth, and seventh spark plugs (not shown). That is, the fifth cylinder passage 320e can be the fifth combustion chamber coupled to the fifth spark plug instead of defining the passive chamber 320. The passive chamber 320, can be defined, instead, by the eighth cylinder passage 320h.

The firing order, for example, can be the first ignition device in communication with the first combustion chamber partially defined by the first cylinder passage 320a; then the fifth ignition device in communication with the fifth combustion chamber partially defined by the fifth cylinder passage 320e; then the fourth ignition device in communication with the fourth combustion chamber partially defined by the fourth cylinder passage 320d; then the second ignition device in communication with the second combustion chamber partially defined by the second cylinder passage 320b; then the sixth ignition device in communication with the sixth combustion chamber partially defined by the sixth cylinder passage 320f; then the third ignition device in communication with the third combustion chamber partially defined by the third cylinder passage 320c; and then the seventh ignition device in communication with a seventh combustion chamber partially defined by the seventh cylinder passage 320g.

Any configuration of an engine having eight cylinder passages, where seven of the eight cylinder passages at least partially define combustion chambers and are in communication with a corresponding ignition device, is contemplated.

Further, this invention can be applied to other V-engine configurations, where the angle is less than 170 degrees and greater than 10 degrees. By way of non-limiting example, a V6 engine operating as a V5 that includes six cylinder passages, where, according to the present invention, five of the six cylinder passages can at least partially define combustion chambers and are in communication with a corresponding ignition device.

Similarly, a V10 engine operating as a V9 that includes ten cylinder passages, where, according to the present invention, nine of the ten cylinder passages can at least partially define combustion chambers and are in communication with a corresponding ignition device.

Benefits of aspects of the disclosure include greater power with the V7 combustion engine that the V8 having the same engine block size. The power increase comes from an ability to increase the bore diameter (cylindrical passage diameter), when one of the eight cylindrical passages is passive.

For example, horsepower in a 3 liter or 183 cubic inch traditional V8 engine having a 3.72 inch bore diameter, a 2.104 inch stroke length, a 1.89 inch inlet, and a 1.61 inch outlet would have a 205 cubic feet per minute intake flow, resulting in approximately 368 horsepower.

In contrast, the horsepower in a 3 liter or 182.9 cubic inch V7 combustion engine, as described herein, having a 3.976 inch bore diameter (for the seven combustion chambers), a 2.104 inch stroke length, a 2.150-2.190 inch inlet, and a 1.61 inch outlet would have a 270 cubic feet per minute intake flow, resulting in approximately 444 horsepower (based on an approximate compression ratio of 10.2:1, where the compression ratio is a ratio of the volume of the combustion chamber when the piston is all the way down or at a first point compared to the volume of the combustion chamber when the piston is at the top or a second point).

While illustrated in a 3 liter engine, any engine size is contemplated.

The improvement in horsepower of the V7 as disclosed can result from the larger bores made possible by the smaller dead or passive cylinder. Additionally, with the larger bores, a larger inlet is also made possible. The larger inlet can improve the supply of the fuel-air mixture to the combustion chamber.

Additional benefits could include fuel economy as the efficiency of the V7 combustion engine is an improvement over the V8 as described.

Further, the combustion firing orders provided herein prevent two adjacent cylinders in the same bank from firing sequentially. It's beneficial to have a firing order that in which the sequentially fired cylinders fire as far apart as possible. This allows a recovery of charge in the intake manifold and promotes a higher level of volumetric efficiency. It also minimizes the interference between adjacent or nearby cylinders that may have overlapping induction periods.

Another advantage of the firing orders, as described herein, preventing two adjacent cylinders in the same bank from firing sequentially, is improved exhausting of combusted gas or material. When two adjacent cylinders on the same bank fire, their exhaust periods traditionally overlap. This overlap generates an exhaust-gas back pressure that can prevent exhaust gasses from escaping one or both of the adjacent cylinders.

The firing orders provided herein prevent robbing of power between adjacent cylinders. Robbing of power can result when a cylinder at its inlet stroke (early in the scavenging portion) robs from the inlet charge of the preceding adjacent cylinder, where the preceding adjacent cylinder has advanced past the scavenging portion of its own inlet stroke.

Additionally, the combustion firing orders provided herein that prevent two adjacent cylinders in the same bank from firing sequentially can improve the engine life. When adjacent cylinders on the same bank fire, additional heat can be provided to portions of the engine that can reduce the overall life of the engine.

Still further, the counterbalance elements locate at or near the passive chamber work to maintain engine balance.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A combustion engine comprising:
an engine block including a body defining an inner engine surface and an outer engine surface;
eight cylinder passages extending from the outer engine surface to the inner engine surface, wherein the eight cylinder passages are arranged as a first bank arranged along a first axis and a second bank arranged along a second axis, with each of the first bank and the second bank including four of the eight cylinder passages, and wherein the first bank and the second bank are arranged at a bank angle between 50-degree and 120-degrees;
eight pistons, wherein each piston of the eight pistons is received by one cylinder passage of the eight cylinder passages;
a crankshaft coupled to the eight pistons and at least partially journaled within the engine block;
seven ignition devices in communication with seven cylinder passages of the eight cylinder passages; and
a timing mechanism to control timing of the seven ignition devices, wherein one ignition device of the seven ignition devices is ignited at every 102.85 to 102.86 degrees of rotation of the crankshaft.

2. The combustion engine of claim 1, wherein the eight pistons are sized complementary to sidewalls of the eight cylinder passages.

3. The combustion engine of claim 2, wherein seven of the eight cylinder passages in communication with the seven ignition devices define seven combustion chambers, with each combustion chamber including a corresponding cylinder head.

4. The combustion engine of claim 3, wherein each combustion chamber of the seven combustion chambers includes an inlet and an outlet, wherein an air-fuel mixture is received by the inlet and combusted gasses are exhausted through the outlet.

5. The combustion engine of claim 4, wherein the inlet and the outlet include an inlet valve and an outlet valve selectively opened by a set of pushrods coupled to a camshaft.

6. The combustion engine of claim 4, wherein the inlet and the outlet include an inlet valve and an outlet valve selectively opened by an overhead cam assembly.

7. The combustion engine of claim 4, wherein the inlet for each combustion chamber includes a diameter between 2.150-2.190 inches.

8. The combustion engine of claim 2, wherein a firing order for the seven ignition devices is:
a second ignition device in communication with a second combustion chamber partially defined by a second cylinder passage; then
a first ignition device in communication with a first combustion chamber partially defined by a first cylinder passage; then
a seventh ignition device in communication with a seventh combustion chamber partially defined by an eighth cylinder passage; then
a fourth ignition device in communication with a fourth combustion chamber partially defined by a fourth cylinder passage; then
a third ignition device in communication with a third combustion chamber partially defined by a third cylinder passage; then
a sixth ignition device in communication with a sixth combustion chamber partially defined by a sixth cylinder passage; and
a fifth ignition device in communication with a fifth combustion chamber partially defined by a fifth cylinder passage.

9. The combustion engine of claim 1, wherein the eight cylinder passages define eight diameters, and wherein at least two diameters of the eight diameters are different.

10. The combustion engine of claim 9, wherein at least one diameter of the eight diameters is greater than 3.72 inches.

11. The combustion engine of claim 10, wherein a ratio of a stroke length to the at least one diameter of the eight diameters is less than 1.

12. The combustion engine of claim 1, wherein the combustion engine is a short-stroke combustion engine.

13. The combustion engine of claim 1, wherein the bank angle is equal to 60 degrees or 90 degrees.

14. The combustion engine of claim 1, wherein an electrical signal received by each of the ignition devices occurs every 102.8571 degrees of rotation of the crankshaft.

15. A combustion engine comprising:
an engine block with a set of eight cylinder passages arranged as a first bank of four cylinder passages and a second bank of the remaining four of the eight cylinder passages, wherein the first bank is arranged at a v-angle relative to the second bank, and the v-angle is between 50-degrees and 120-degrees;
a set of eight pistons;
a crankshaft coupled to the set of eight pistons and at least partially journaled within the engine block;
seven ignition devices in communication with seven cylinder passages of the set of eight cylinder passages; and
a timing mechanism operably coupled to the seven ignition devices, wherein the timing mechanism ignites one ignition device of the seven ignition devices at every 102.85 to 102.86 degrees of rotation of the crankshaft.

16. The combustion engine of claim 15, wherein the set of eight cylinder passages define eight diameters, wherein at least two diameters of the eight diameters are different.

17. The combustion engine of claim 16, wherein at least one of the eight diameters is greater than 3.72 inches.

18. The combustion engine of claim 15, wherein a bank angle is equal to 60 degrees or 90 degrees.

19. A method of driving a combustion engine having an engine block wherein eight pistons coupled to a common crankshaft are received by the engine block, and seven ignition devices, the method comprising:
driving the crankshaft with seven pistons of the eight pistons, wherein the seven pistons of the eight pistons partially define seven combustion chambers in communication with the seven ignition devices;
wherein driving the seven pistons is timed such that one of the seven ignition devices initiates combustion every 102.85 to 102.86-degrees of rotation of the crankshaft.

20. The method of claim 19, wherein a firing order for the ignition devices is:
a first ignition device in communication with a first combustion chamber; then
a seventh ignition device in communication with a seventh combustion chamber; then
a fourth ignition device in communication with a fourth combustion chamber; then
a third ignition device in communication with a third combustion chamber; then
a sixth ignition device in communication with a sixth combustion chamber; then
a fifth ignition device in communication with a fifth combustion chamber; and
a second ignition device in communication with a second combustion chamber.
